(19) United States
(12) Patent Application Publication
(10) Pub. No.: US 2016/0026984 A1
(43) Pub. Date: Jan. 28, 2016

(54) STORAGE APPARATUS AND CONTROL METHOD OF STORAGE APPARATUS

(71) Applicant: Hitachi, Ltd., Tokyo (JP)

(72) Inventors: Daisuke SAGANO, Tokyo (JP); Hirofumi FUJITA, Tokyo (JP); Ryo TAKASE, Tokyo (JP); Akira NISHIMOTO, (US)

(73) Assignee: HITACHI, LTD., Tokyo (JP)

(21) Appl. No.: 14/342,289

(22) PCT Filed: Apr. 15, 2013
(86) PCT No.: PCT/JP2013/061151

§ 371 Date: Feb. 28, 2014

(51) Int. Cl. G06Q 20/14; G06F 3/06

(52) U.S. Cl. CPC G06Q 20/145; G06F 3/0605; G06F 3/0653; G06F 3/067

(57) ABSTRACT

A storage apparatus with which billing amounts in the case of write count-dependent billing can be predicted, comprises a physical storage device which provides logical volumes of different types, and a controller which executes I/O control by classifying each of the logical volumes of different types into tiers of different response performances. In a case where a write request is issued to any virtual page which configures the virtual volume, the controller assigns any real page which configures a logical volume to the virtual page, writes data to the real page, and performs a write count. The controller calculates a billing amount per fixed time interval on the basis of the performed write count, calculates tier ranges so that the billing amount per fixed time interval does not exceed the billing upper limit value, and relocates the real page on the basis of the calculated tier range.

### TECHNICAL FIELD

The present invention relates to a storage apparatus and a control method of a storage apparatus, and more particularly relates to a storage apparatus and a control method of a storage apparatus with which tiered control according to a write count-based billing amount is performed.

### BACKGROUND ART

PTL 1 discloses a technology which migrates data in page units by using data migration technology, storage tiering technology, and thin provisioning.

Data migration technology is a technology with which data stored in a first logical volume is migrated to a second logical volume, and storage tiering technology is technology with which a plurality of logical volumes are classified in any of a plurality of tiers and a logical volume thus classified in any tier is migrated to another tier. Tiers include high-reliability tiers and low-cost tiers.

Further, thin provisioning refers to a technology with which, when a write request has been issued from a higher level device to a plurality of virtual storage areas (virtual pages) which a virtual logical volume (virtual volume) comprises, real storage areas (real pages) are assigned to the virtual pages and data corresponding to the write request is written to the real pages.

Further, PTL 2 discloses a technology with which access degree information indicating the degree to which a higher level device accesses a storage apparatus is acquired, and a storage service fee is calculated based on the acquired access degree information.

More specifically, the storage service fee is calculated according to a basic fee+an access frequency×a billing fee per access count+an access block total count×a billing fee per access block total count. This technology is intended to curb fees paid by customers who barely use the storage apparatus.

### CITATION LIST

### Patent Literature

[PTL 1]

International Patent Publication No. 2011/077489

[PTL 2]

JP-A-2006-209799

### SUMMARY OF INVENTION

### Technical Problem

Further, in an environment where a plurality of users share logical volumes in a storage apparatus as in the case of a cloud rental business, when billing is to be performed based on the usage capacities of virtual volumes used by conventional users by using the technology disclosed in PTL 1, inequalities may arise between users with different data write destinations and write counts.

For example, if billing amounts are set to be the same because the usage amounts of the virtual volumes used by the users are identical, writing data to SSD (Solid State Drive)-provisioned logical volumes is more advantageous to the user than writing data to SAS (Serial Attached SCSI) or SATA (Serial ATA)-provisioned logical volumes.

An SSD provides a higher response performance than SAS or SATA and needs to be exchanged due to degradation which is in proportion to the write count. That is, an SSD is a high-performance and high-cost drive. SAS or SATA, on the other hand, provides a lower response performance than an SSD but does not need to be replaced since there is barely any degradation. That is, an SAS or SATA is a low-performance and low-cost drive.

Therefore, in the case of identical billing amounts, configuring the data write destination as an SSD-provisioned logical volume is highly advantageous to the user and having a multiplicity of write counts with which data is written to the SSD is very advantageous to the user. Accordingly, there are inequalities between users who benefit greatly in this way and users for whom data is written to SAS or SATA.

Meanwhile, supposing that billing is performed according to the write count with which data is actually written to physical storage devices (SSD, SAS, or SATA) by simply combining the technology disclosed in PTL 1 with the technology disclosed in PTL 2, there is a problem in that there are very few users performing writing which considers the write count, and the amount which is billed according to the writing cannot be predicted.

For example, even in a case where the write count of a user for writing data to a virtual page in a virtual volume is only one, a real page which has been assigned to the virtual page by the storage tiering technology is migrated between a plurality of tiers. Furthermore, in each migration, data is written to a real page at the migration destination. In other words, because data writing occurs at moments which are unplanned by the user, billing amounts are unpredictable.

The present invention was conceived in light of the above points and proposes a storage apparatus and a control method of a storage apparatus with which billing amounts in the case of write count-dependent billing can be predicted.

### Solution to Problem

In order to solve the foregoing problems, a storage apparatus according to the present invention is a storage apparatus which calculates a billing amount in accordance with a data write count, comprising a physical storage device which provides logical volumes of different types; and a controller which executes I/O control by classifying each of the logical volumes of different types into tiers of different response performances and associating each of the logical volumes which belong to any of the tiers with a virtual volume provided to a higher level device, wherein, in a case where a write request is issued to any virtual page which configures the virtual volume, the controller assigns any real page which configures a logical volume to the virtual page, writes data to the real page, and performs a write count, wherein the controller calculates a billing amount per fixed time interval on the basis of the performed write count, wherein the controller calculates tier ranges so that the billing amount per fixed time interval does not exceed the billing upper limit value, and wherein the controller relocates the real page on the basis of the calculated tier range.

In order to solve the foregoing problem, the storage apparatus control method according to the present invention is a control method of a storage apparatus which calculates a billing amount in accordance with a data write count, comprising a first step in which a physical storage device provides logical volumes of different types; and a second step in which a controller executes I/O control by classifying each of the logical volumes of different types into tiers of different response performances and associating each of the logical volumes which belong to any of the tiers with a virtual volume provided to a higher level device, and comprising, in the second step, a third step in which, in a case where a write request is issued to any virtual page which configures the virtual volume, any real page which configures the logical volume is assigned to the virtual page, data is written to the real page, and a write count is performed; a fourth step in which a billing amount per fixed time interval is calculated on the basis of the performed write count; a fifth step in which tier ranges are calculated so that the billing amount per fixed time interval does not exceed the billing upper limit value; and a sixth step in which the real page is relocated on the basis of the calculated tier range.

### Advantageous Effects of Invention

According to the present invention, billing amounts in the case of write count-dependent billing can be predicted.

### BRIEF DESCRIPTION OF DRAWINGS

FIG. 1 is a schematic diagram serving to provide an overview of billing management processing according to this embodiment.

FIG. 2 is an overall configuration diagram of a storage system according to this embodiment.

FIG. 3 is an internal configuration diagram of memory.

FIG. 4 is a logical configuration diagram of a write count management table.

FIG. 5 is a logical configuration diagram of a write cost management table.

FIG. 6 is a logical configuration diagram of an allocation table.

FIG. 7 is a logical configuration diagram of a migration page table.

FIG. 8 is a logical configuration diagram of a frequency distribution table.

FIG. 9 is a conceptual view of a frequency distribution graph and a tier range.

FIG. 10 is a flowchart indicating fee management processing.

FIG. 11 is a flowchart indicating write count management table update processing.

FIG. 12 is a flowchart showing tier range calculation processing for reducing billing amounts.

FIG. 13 is a flowchart showing tier range calculation processing for increasing billing amounts.

FIG. 14 is a flowchart showing migration processing.

### DESCRIPTION OF EMBODIMENTS

Embodiments of the present invention are now described in detail with reference to the drawings.

(1) Overview of Present Embodiment

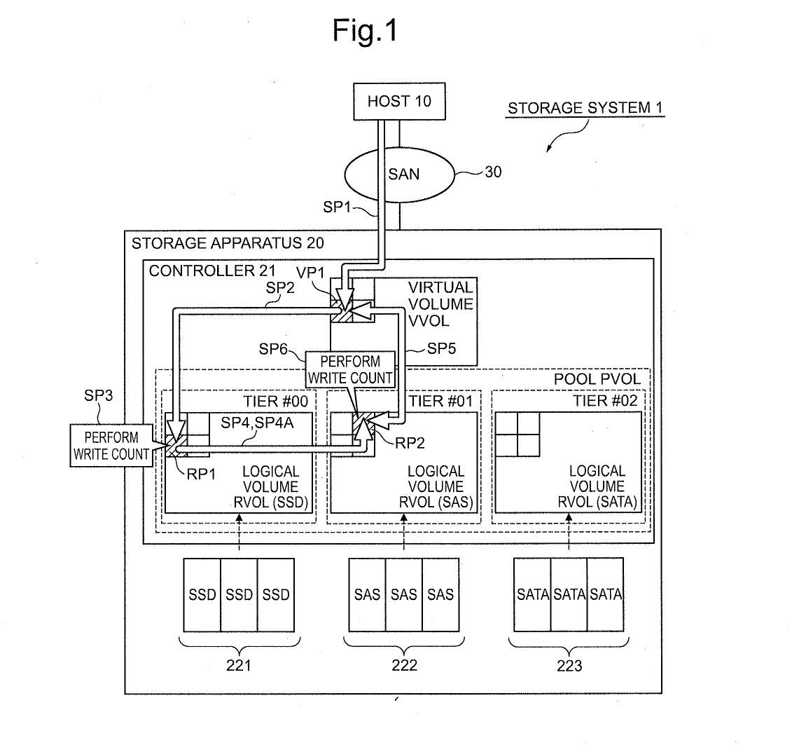

FIG. 1 shows an overview of a storage system 1 according to this embodiment and an overview of billing management processing. This embodiment is devised such that, in the storage system 1, a configuration is adopted whereby, if a write request is issued from a host 10 to a virtual logical volume (virtual volume) VVOL via the SAN (Storage Area Network) 30, data is written to a real logical volume RVOL associated with the virtual volume VVOL, billing amounts for users of the host 10 are calculated according to the writing to the logical volume RVOL, and inequalities between users which arise in the case of usage capacity-dependent billing are resolved.

In addition, a storage apparatus 20 according to this embodiment comprises a built-in storage tiering function. The storage tiering function is a function which migrates data which is stored in a real page between tiers such that data with a high I/O frequency is stored in a logical volume RVOL which belongs to a high-performance tier and data with a low I/O frequency is stored in a logical volume RVOL which belongs to a low-performance tier, and is a function enabling curbing of costs and implementation of expedited processing.

In this case, each time a real page assigned to a virtual page is migrated between tiers, data writing is generated at times unexpected by the user and billing amounts cannot be predicted. Therefore, according to this embodiment, a configuration is adopted whereby the real page migration source and migration destination are changed by changing the tier ratio of the virtual volume VVOL such that the billing amount approaches an upper limit value for the billing amount which is predetermined by the user, thereby preventing the billing amount from exceeding a billing upper limit value.

Furthermore, according to this embodiment, a configuration is adopted whereby, if the billing amount is lower than the upper limit value, the tier range is changed to improve performance, thereby preventing the billing amount from exceeding the billing upper limit value while improving performance.

First, the configuration based on the premise of this embodiment will be described. A controller 21 in the storage apparatus 20 aggregates and manages, in aggregate areas of real pages called pool volumes PVOL, logical volumes RVOL (SSD) provided by SSD 221, logical volumes RVOL (SAS) provided by SAS 222, and logical volumes RVOL (SATA) provided by SATA 223 respectively, and performs tier management using the tiers #00, #01, and #02 within the pool volumes PVOL.

Further, the controller 21 performs management such that logical volumes RVOL of the same one type belong to tiers of the same type. Here, management is performed such that the logical volumes RVOL (SSD) belong to tier #00, the logical volumes RVOL (SAS) belong to tier #01, and the logical volumes RVOL (SATA) belong to tier #02. Among these tiers #00 to #02, the tier #00 has the highest response performance and the highest cost, the tier #01 has the next highest response performance and cost, and the tier #02 has the lowest response performance and the lowest cost.

The logical volumes RVOL which belong to these tiers #00 to #02 each comprise a plurality of real pages, and if a write request is issued to a virtual page, the controller 21 actually writes data to any physical storage device among the SSD 221, SAS 222, and SATA 223 by dynamically assigning the real pages to virtual storage areas (virtual pages) in the virtual volume WOL.

Further, the controller 21 continually monitors the I/O frequency of all the virtual pages which constitute the virtual volume WOL, and re-arranges the real pages (storage tiering function) on the basis of the I/O frequency obtained as the monitoring result.

For example, if a write request is issued to one virtual page in the virtual volume VVOL, the controller 21 monitors the I/O frequency of the virtual page at predetermined intervals once the data has been written to one real page in a logical volume RVOL (SSD) which belongs to the tier #00. Further, if the I/O frequency of the virtual page obtained as the monitoring result is less than a predetermined I/O frequency, the controller 21 migrates the data, thus written to the real page, from tier #00 to a free real page in a logical volume RVOL (SAS) which belongs to tier #01, and relocates the real page by associating the real page with the virtual page.

An overview of the billing management processing according to this embodiment will be described next. First, upon receiving a write request issued from the host 10 via the SAN 30 (SP1), the controller 21 in the storage apparatus 20 determines whether a real page RP1 in the logical volume RVOL which belongs to the tier #00 has been assigned to a virtual page VP1 designated in the write request, and if the real page RP1 has been assigned to the virtual page VP1, the controller 21 writes the data associated with the write request to the real page RP1 (SP2).

Note that, if the real page RP1 has not been assigned to the virtual page VP1, the controller 21 assigns the real page RP1 to the virtual page VP1 before then writing data which is associated with the write request to the real page RP1.

The real page RP1 is a real storage area in a logical volume RVOL provided by the SSD 221 and data is written to the real page RP1, in other words, data is actually written to the SSD 221. Therefore, at this time, the controller 21 counts the write count after data is actually written to the SSD 221 (SP3).

Meanwhile, the controller 21 continually monitors the I/O frequency of the virtual page VP1 by means of the storage tiering function and continually monitors the billing amount, and if it is predicted that the billing amount will exceed a preset billing upper limit value, the controller 21 relocates the real page to reduce the billing amount. Conversely, if it is predicted that the billing amount will be lower than the billing upper limit value, the controller 21 relocates the real page to increase the billing amount (improve the performance).

For example, if it is predicted that the billing amount will exceed the billing upper limit value and the I/O frequency of the virtual page VP1 is small (if the I/O frequency is no more than a predetermined value), the controller 21 changes (reduces) the tier range of tier #0 which has a high response performance and a high billing amount per unit count, and changes the tier to be assigned to the virtual page VP1 from tier #00 to tier #01 which has a lower response performance than this tier #00.

The controller 21 then migrates the data of the real page RP1 assigned to the virtual page VP1 to the real page RP2 (SP4), associates the migration destination real page RP2 with the virtual page VP1 (SP5), and relocates the real page. Further, the controller 21 then counts the write count after actually writing data to the SAS 222 (SP6).

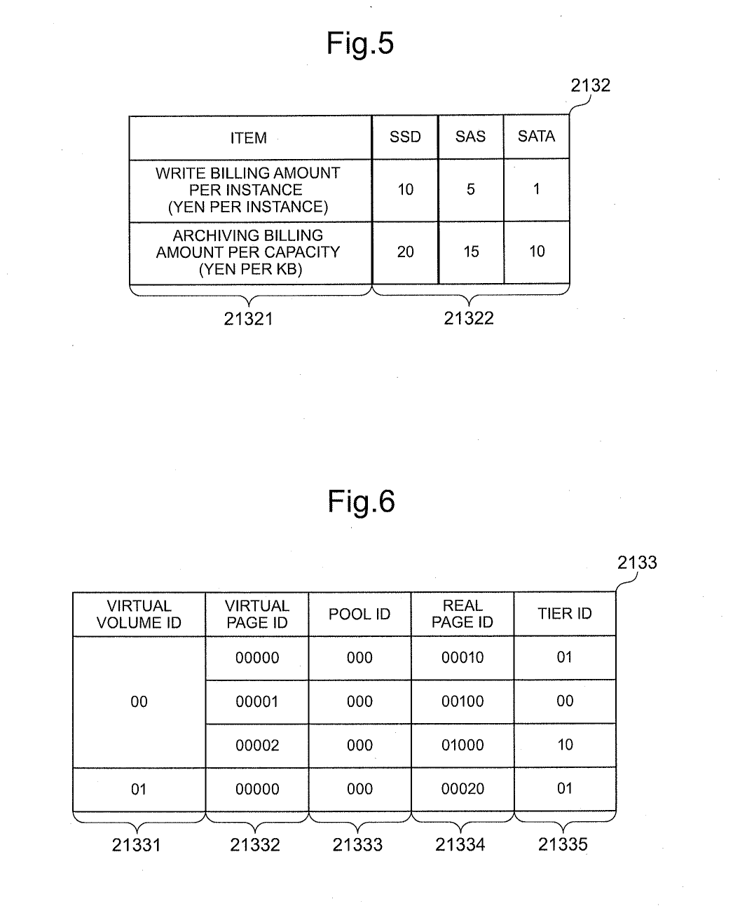

The controller 21 calculates the billing amount on the basis of the write count thus counted in steps SP3 and SP6 and determines whether or not the billing amount exceeds the billing amount upper limit value. Note that, as the billing amount calculation method, for example, the controller 21 calculates the billing amount as the billing amount (the billing amount per unit count) in the case of one write instance to the SSD 221×the write count. In this embodiment, the billing amount per unit count is set to be different for the SSD 221, SAS 222, and SATA 223 respectively (FIG. 5).

Further, the controller 21 relocates the real page so that the billing amount is reduced in a case where [the billing amount upper limit value] is exceeded, and in a case where the billing amount is lower [than the billing amount upper limit value], the controller 21 relocates the real page to improve performance and performs control so that the billing amount approaches the billing amount upper limit value by repeating the real page re-disposition processing.

Note that here a case was described where data is written to a real page in a logical volume RVOL provided by the SSD 221 and SAS 222, but billing may be performed in the same way also in a case where data is written to a real page in a logical volume RVOL provided by the SATA 223. Conversely, billing may be limited to a case where data is written to the SSD 221 and billing may not be performed in a case where data is written to the SAS 222 and the SATA 223.

According to this embodiment, because billing is performed according to the write count, inequalities arising between users can be resolved in comparison with a case where billing is performed according to the usage capacity. Further, according to this embodiment because the tier range is changed according to a set billing amount and the billing amount is changed, the billing amount can be easily predicted. Further, according to this embodiment, in a case where the predicted billing amount exceeds the billing amount upper limit value, the tier range is changed to reduce the billing amount, and conversely in a case where the predicted billing amount is lower than the billing amount upper limit value, the tier range is changed to improve performance, whereby the billing amount can be predicted while improving performance. In addition, a user who is not aware of the write count can also be prevented from receiving an unexpectedly high bill.

The storage apparatus and billing method according to this embodiment will be described in detail hereinbelow with reference to the drawings.

(2) Overall Configuration

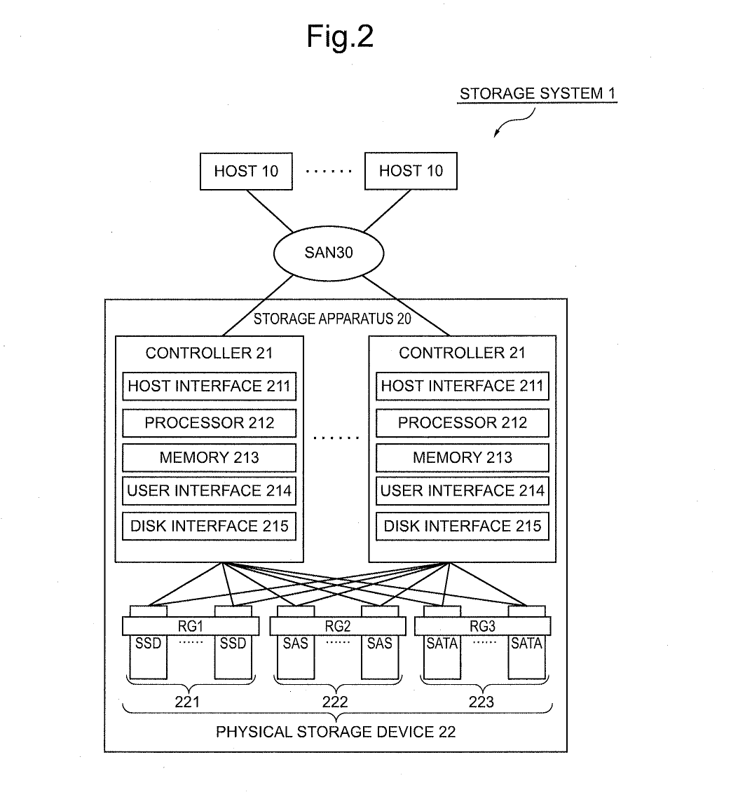

FIG. 2 shows the overall configuration of the storage system 1. The storage system 1 is configured by communicably connecting a plurality of hosts 10 to the storage apparatus 20 via an SAN 30.

The host 10 is a general computer which is configured from a processor, a memory, and a communication device, and the like, and issues an I/O request to the storage apparatus 20 which is connected to the SAN 30. The I/O request contains information serving to specify the write or read destination and contains the ID of a virtual volume WOL and the ID of a virtual page, for example. Note that, as the ID of the virtual volume WOL, there exists a LUN (Logical Unit Number), and as the ID of the virtual page, there exists an LBA (Logical Block Address).

The storage apparatus 20 is configured from a plurality of controllers 21 and a plurality of physical storage devices 22, and upon receiving an I/O request from the host 10, specifies the virtual volume VVOL and virtual page of the I/O request destination, performs the assignment of a real page to the specified virtual volume WOL and virtual page and carries out the reading and writing of data corresponding to the I/O request from/to the real page.

The controller 21 is configured from a host interface 211, a processor 212, a memory 213, a user interface 214, and a disk interface 215.

The host interface 211 is an interface which is connected to the host 10 via the SAN 30, and upon receiving an I/O request from the host 10, transfers the received I/O request to the processor 212.

The processor 212 is a device which centrally controls the operation of the controller 21 and, upon receiving an I/O request from the host interface 211, for example, executes processing corresponding to the received I/O request.

The memory 213 is a volatile or involatile memory and stores various programs and various tables. The user interface 214 is an interface which inputs operations from the user and is a keyboard, a mouse, and a display, for example.

The disk interface 215 is an interface which is connected to a plurality of physical storage devices 22, and which reads data stored in the physical storage devices 22 and writes the data to the memory 213, and which conversely writes data temporarily stored in the memory 213 to the physical storage devices 22.

The physical storage devices 22 are configured from physical storage devices of a plurality of types and are configured, for example, from a plurality of SSD 221, a plurality of SAS 222, and a plurality of SATA 223. These physical storage devices 22 of a plurality of types constitute RAID (Redundant Array of Independent Disks) groups RG1 to RG3 respectively and are provided by logical volumes RVOL with a different response performance from the RAID groups RG1 to RG3. These logical volumes RVOL are aggregated in the pool volume PVOL by the controller 21 and are disposed in the tiers #00 to #02 respectively which are tiered for each response performance.

(3) Internal Configuration

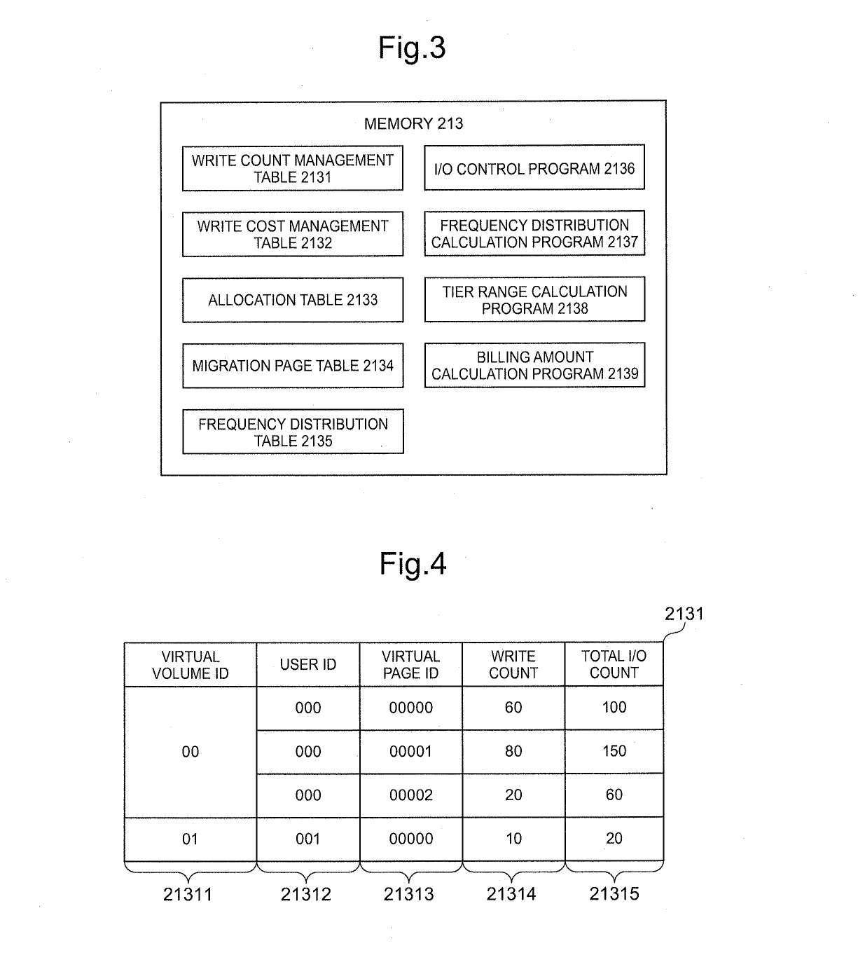

FIG. 3 shows the internal configuration of the memory 213. The memory 213 stores a write count management table 2131, a write cost management table 2132, an allocation table 2133, a migration page table 2134, and a frequency distribution table 2135. Each of these tables will be described in detail subsequently (FIGS. 4 to 8).

Further, the memory 213 stores an I/O control program 2136, a frequency distribution calculation program 2137, a tier range calculation program 2138, and a billing amount calculation program 2139. The I/O control program 2136 is a program for executing processing (real page assignment or the like) corresponding to the I/O request from the host 10, and is a program for executing migration processing which migrates data stored in a real page at regular intervals to another real page.

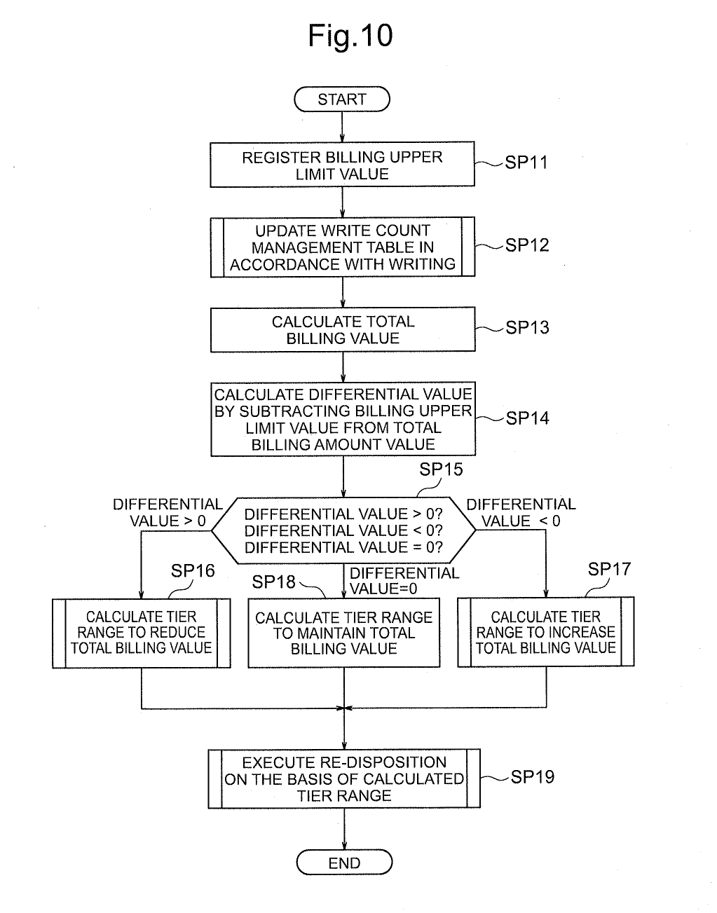

The frequency distribution calculation program 2137 is a program for creating the frequency distribution table 2135. The tier range calculation program 2138 is a program which references the frequency distribution table 2135 to calculate the tier range. The billing amount calculation program 2139 is a program for calculating the billing amount according to the write count. The processing executed by each of these programs will be described in detail subsequently (FIGS. 10 to 14).

(4) Details of Each Configuration

FIG. 4 shows the logical configuration of the write count management table 2131. The write count management table 2131 is a table which is created when the I/O control program 2136 executes I/O processing and stores the write count of data required to calculate the billing amount and the total I/O count.

More specifically, the write count management table 2131 is configured from a virtual volume ID field 21311, a user ID field 21312, a virtual page ID field 21313, a write count field 21314, and a total I/O count field 21315.

The virtual volume ID field 21311 stores identification information for specifying virtual volumes VVOL. The user ID field 21312 stores identification information for specifying users, and the virtual page ID field 21313 stores identification information for specifying virtual pages.

Further, the write count field 21314 stores the write counts for when data is actually written to the real pages assigned to the virtual pages, and the total I/O count field 21315 stores the total of the write counts when data is actually written to the real pages assigned to the virtual pages and the read counts when data is read from the real pages.

Therefore, in the case of FIG. 4, it can be seen that the virtual volume VVOL with the virtual volume ID “00” is used by the user (host 10) with the user ID “000”, and among the plurality of virtual pages constituting this virtual volume VVOL, the virtual page with the virtual page ID “00000” has an actual write count of “60” and a total I/O count of “100”.

Note that the write count field 21314 and the total I/O count field 21315 may store the write count and total I/O count for each type of physical storage device 22. For example, the write count field 21314 may store write counts for each type of physical storage device 22 such that the write count for the SSD 221 is 40, the write count for the SAS 222 is 10, and the write count for the SATA 223 is 10.

FIG. 5 shows the logical configuration of the write cost management table 2132. The write cost management table 2132 is a table which is created by being preset by the administrator of the storage apparatus 20 and which stores costs in a case where data is actually written.

More specifically, the write cost management table 2132 is configured from a billing item field 21321 and a billing amount item field 21322. The billing item field 21321 stores billing items and the billing amount item field 21322 stores billing amounts.

Therefore, in the case of FIG. 5, it is clear that the write billing amount per unit count for the SSD 221 in a case where the billing item is “write billing amount per instance” (yen per instance)” is “10” yen, that the write billing amount per unit count for the SAS 222 is “5” yen, and that the write billing amount per unit count for the SATA 223 is “1” yen.

Further, it is clear that the billing amount for archiving in the SSD 221 in a case where the billing item is “archive billing amount per capacity (yen/KB)” is “20” yen, that the archive billing amount for the SAS 222 is “15” yen, and that the archive billing amount for the SATA 223 is “10” yen.

Note that here it is stated that the write billing amount for each unit count for the SAS 222 and SATA 223 is “5” yen and “1” yen but may also be defined as “0” yen since the SAS 222 and SATA 223 do not degrade due to the write count.

In addition, although the billing amount for each unit write count is defined here, the billing amount per unit write data amount may also be defined such that billing is performed according to the write data amount, for example. Flash memory degrades due to the erase count. Although the write count and erase count are approximately proportional to one another, if the write data amount is large, the erase count may be plural even when the write count is one. Therefore, billing may be performed according to the write data amount so that the write count is closer to being proportional to the erase count.

FIG. 6 shows the logical configuration of the allocation table 2133. The allocation table 2133 is a table which is created when the I/O control program 2136 assigns real pages to the virtual pages, and stores information showing the correspondence relationship between the virtual pages and real pages.

More specifically, the allocation table 2133 is configured from a virtual volume ID field 21331, a virtual page ID field 21332, a pool ID field 21333, a real page ID field 21334, and a tier ID field 21335.

The virtual volume ID field 21331 stores identification information for specifying the virtual volumes VVOL. The virtual page ID field 21332 stores identification information for specifying the virtual pages. The pool ID field 21333 stores identification information for specifying the pool volumes PVOL. The real page ID field 21334 stores identification information for specifying the real pages. The tier ID field 21335 stores identification information for specifying the tiers.

Therefore, in the case of FIG. 6, it can be seen that the virtual volume VVOL with the virtual volume ID is “00” is configured comprising a plurality of virtual pages with the virtual page IDs “00000”, “00001”, and “00002”, and that the real page which is assigned to the virtual page “00000” among these virtual pages belongs to the pool volume PVOL with the pool ID “000”, has a real page ID of “00010”, and belongs to the tier with the tier ID “01”.

Note that the allocation table 2133 according to this embodiment may also be stored in the physical storage device 22 of the storage apparatus 20, for example, in addition to being stored in the memory 213 of the storage apparatus 20 to also enable management by the user of the host 10. In this case, the host 10 is able to issue a read request to the storage apparatus 20 and acquire the allocation table 2133.

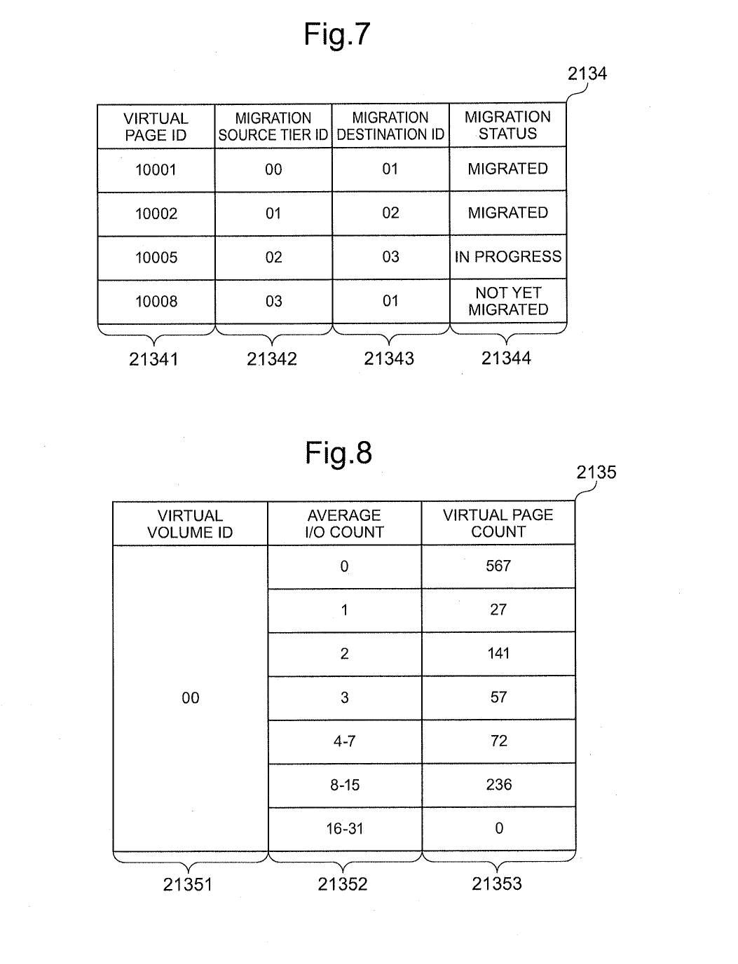

FIG. 7 shows the logical configuration of the migration page table 2134. The migration page table 2134 is a table which is created in a case where the I/O control program 2136 migrates the data stored in a real page to a real page belonging to another tier, and store information and statuses showing the correspondence relationship between the migration source and migration destination.

More specifically, the migration page table 2134 is configured from a virtual page ID field 21341, a migration source tier ID field 21342, a migration destination tier ID field 21343, and a migration status field 21344.

The virtual page ID field 21341 stores identification information for specifying virtual pages. The migration source tier ID field 21342 stores identification information for the migration source tier to which the real page assigned to the virtual page belongs. The migration destination tier ID field 21343 stores identification information for the migration destination tier in a case where data stored in a real page is migrated. The migration status field 21344 stores migration states.

Therefore, in the case of FIG. 7, it is clear that the real page assigned to the virtual page with the virtual page ID “10001” belongs to the tier with the migration source tier ID “00”, and that the data stored in the real page is migrated to the real page which belongs to the tier with the migration destination tier ID “01”. Further, it can be seen that the migration state of the data which is stored in the real page is already “migrated”.

FIG. 8 shows the logical configuration of the frequency distribution table 2135. The frequency distribution table 2135 is a table which is created as a result of the controller 21 monitoring the I/O count at regular intervals, and stores information showing the correspondence relationship between the I/O frequency and the number of virtual pages.

More specifically, the frequency distribution table 2135 is configured from a virtual volume ID field 21351, an average I/O count field 21352, and a virtual page count field 21353. The virtual volume ID field 21351 stores identification information for specifying the virtual volumes WOL. The average I/O count field 21352 stores the average I/O counts of the virtual pages. The virtual page count field 21353 stores the virtual page counts corresponding to the average I/O counts.

Therefore, in the case of FIG. 8, it can be seen that, in the virtual volume WOL with the virtual volume ID “00”, the virtual page with the average I/O count “0” is page “567”. Note that although the average I/O count is stored here as I/O frequency information, [the embodiment] is not limited to this configuration, rather, the total I/O count within a monitoring time, for example, may also be stored.

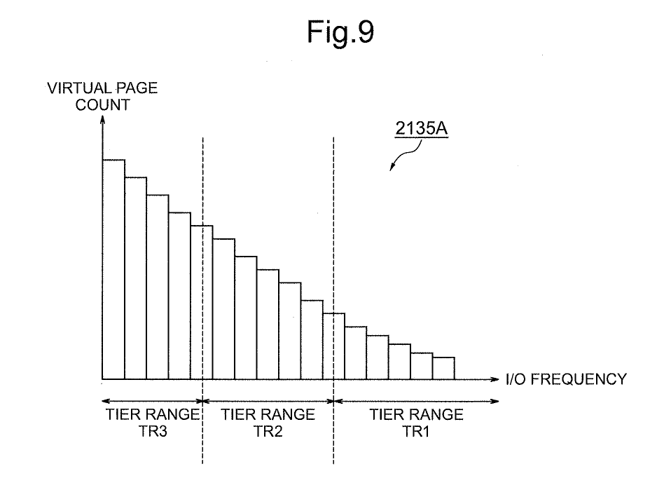

FIG. 9 shows a conceptual view of a frequency distribution table 2135A and tier ranges TR1 to TR3. The frequency distribution table 2135A is a graph which is created on the basis of the frequency distribution table 2135 by means of the frequency distribution calculation program 2137, and is used to calculate the tier ranges TR1 to TR3. The vertical axis represents the virtual page count and the horizontal axis represents the I/O frequency.

Therefore, in the case of FIG. 9, it can be seen that, for a plurality of virtual pages which constitute one virtual volume VVOL, there are multiple virtual pages with a low I/O frequency and that, the greater the I/O frequency is, the smaller the corresponding virtual page becomes.

The tier ranges TR1 to TR3 are tier ratios (tier ranges) of the virtual volume VVOLs which the tier range calculation program 2138 calculates by using the frequency distribution table 2135A. The tier range TR1 is the tier ratio of the tier #00 of one virtual volume VVOL. Similarly, the tier range TR2 is the tier ratio of tier #01 and the tier range TR3 is the tier ratio of the tier #02.

The tier ranges TR1 to TR3 are determined as follows. That is, the tier range calculation program 2138 sets an infinite I/O count as the upper limit value, and, for the lower limit value, in a case where the sum total of the virtual page counts is found by working through the counts toward progressively smaller I/O frequencies from the upper limit value and the upper limit value for the number of tier #00-assignable real pages has been reached, the tier range calculation program 2138 sets the I/O frequency at this time as the lower limit value.

For the tier range TR2, the tier range calculation program 2138 sets, as the upper limit value, an I/O frequency which is the same as the I/O frequency of the lower limit value of the tier range TR1 or an I/O frequency which is only a predetermined amount higher than the foregoing I/O frequency, and for the lower value, similarly to the setting of the lower limit value of the tier range TR1, in a case where the sum total of the virtual page counts is found by working through the counts toward progressively smaller I/O frequencies from the upper limit value and the upper limit value for the number of tier #01-assignable real pages has been reached, the tier range calculation program 2138 sets the I/O frequency at this time as the lower limit value.

For the tier range TR3, the tier range calculation program 2138 sets, as the upper limit value, an I/O frequency which is the same as the I/O frequency of the lower limit value of the tier range TR2 or an I/O frequency which is only a predetermined amount higher than the foregoing I/O frequency, and sets the lower limit value to 0.

Further, according to this embodiment, the migration source and migration destination are determined such that a virtual page contained in any tier range among the tier ranges TR1 to TR3 is put in another tier range according to the billing amount.

In a case where the billing amount exceeds the preset billing upper limit value, for example, the tier ratio is changed so that a virtual page with a low I/O frequency among the virtual pages contained in the tier range TR1 is put in the tier range TR2, and the migration page table 2134 is updated by configuring the migration source as the tier #00 and the migration destination as the tier #01.

In addition, in a case where the billing amount is lower than the billing upper limit value, the tier ratio is changed so that, among the virtual pages contained in the tier range TR2, a virtual page with a high I/O frequency is put in the tier range TR1, and the migration page table 2134 is updated by configuring the migration source as the tier #01 and the migration destination as the tier #00.

Accordingly, the migration source and migration destination are determined so that the virtual pages are put in any of the tier ranges according to the billing amount, and by executing re-disposition of the real pages on the basis of the migration source and migration destination (migration page table 2134) thus determined, the performance of the whole storage system 1 can be improved without the billing amount exceeding the billing upper limit value.

(5) Flowchart

FIG. 10 shows a processing routine of billing management processing. The billing management processing is executed at regular intervals or in response to user operation on the basis of the I/O control program 2136, the various programs of the tier range calculation program 2138 and the billing amount calculation program 2139, and the processor 212. For the sake of convenience in the description, the entity performing this processing will be described as the processor 212 or the various programs.

First, when a billing upper limit value is input by the administrator via the user interface 214 or the management apparatus (not shown), the processor 212 configures the input billing upper limit value in the storage apparatus 20 (SP11).

Subsequently, in predetermined monitoring periods, the I/O control program 2136 receives the write request issued from the host and writes the data corresponding to the write request to a real page, migrates the data by means of the storage tiering function and writes the data to the migration destination real page, and when data is written to the real page, updates the write count management table 2131 (SP12).

The billing amount calculation program 2139 then references the write count management table 2131 and the write cost management table 2132 to calculate the total of the billing amounts at each regular interval (billing total value) (SP13).

For example, the billing amount calculation program 2139 references the write count management table 2131 and acquires “60” as the write count of the virtual page with the virtual page ID “00000”. Meanwhile, the billing amount calculation program 2139 references the write cost management table 2132 and acquires “10” yen, “5” yen, or “1” yen as the write billing amount per instance.

The billing amount calculation program 2139 then, in a case where the “60” writes all correspond to the SSD 221, calculates the billing amount as 60×10 yen=600 yen, and calculates the total billing value for the virtual volume VVOL by performing the foregoing calculation for all the virtual pages in the virtual volume VVOL.

The billing amount calculation program 2139 then calculates a differential value by subtracting the billing upper limit value registered in step SP11 from the total billing value calculated in step SP13 (SP14). The billing amount calculation program 2139 subsequently determines whether the differential value is greater than 0, less than 0, or 0 (SP15).

In a case where the differential value is greater than 0, the total billing value exceeds the billing upper limit value. Accordingly, the tier range calculation program 2138 calculates the tier range to reduce the total billing value in the next monitoring period (SP16).

If the differential value is less than 0, the total billing value is smaller than the billing upper limit value. Accordingly, the tier range calculation program 2138 calculates the tier range to increase the total billing value in the next monitoring period (SP17).

If the differential value is 0, the total billing value is the same as the billing upper limit value. Accordingly, the tier range calculation program 2138 calculates the tier range to maintain the total billing value in the next monitoring period (SP18).

The I/O control program 2136 then executes re-disposition of the real page on the basis of the calculated tier range (SP19) before then ending the processing.

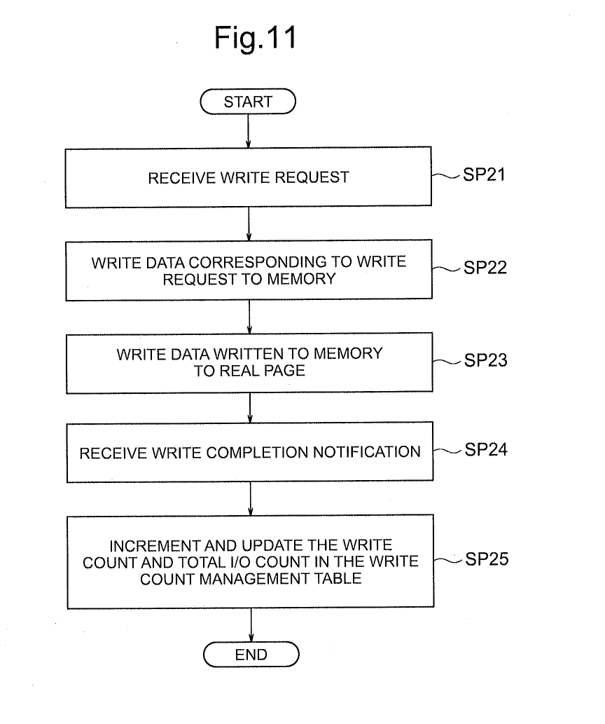

FIG. 11 shows a processing routine of the write count management table update processing. The write count management table update processing is executed on the basis of the I/O control program 2136 and the processor 212 in response to receiving a write request which is issued from the host 10. For the sake of convenience in the description, the entity performing the processing will be described as the I/O control program 2136.

First of all, upon receiving the write request which is issued from the host 10 (SP21), the I/O control program 2136 writes data which corresponds to the received write request to the cache area of the memory 213 (SP22). The I/O control program 2136 subsequently references the allocation table 2133 and writes the data thus written to the cache area of the memory 213 to a real page (SP23).

Subsequently, upon receiving a write completion notification from the disk interface 215 (SP24), the I/O control program 2136 then updates the write count management table 2131 by incrementing the counts in the write count field 21314 and the total I/O count field 21315 in the write count management table 2131 by one (SP25), and ends the processing.

Note that, here, processing has been described in which, in response to receiving the write request issued from the host 10, the I/O control program 2136 writes data to the real page and updates the write count management table 2131, but the processing performed is not necessarily limited to the foregoing processing, rather, in a case where data is read from the migration source real page and a case where data is written to the migration destination real page in response to data being migrated by means of the storage tiering function and re-disposition being executed, the I/O control program 2136 updates the write count management table 2131 in the same way.

In addition, although the write count management table 2131 is updated here with the timing at which data written to the cache area of the memory 213 is written to the real page (destaging timing) (SP23 and SP25), the embodiment is not limited to such timing, rather, the write count management table 2131 may also be updated with the timing with which data is read from the cache area or data is written to the cache area in accordance with an I/O request issued from the host 10.

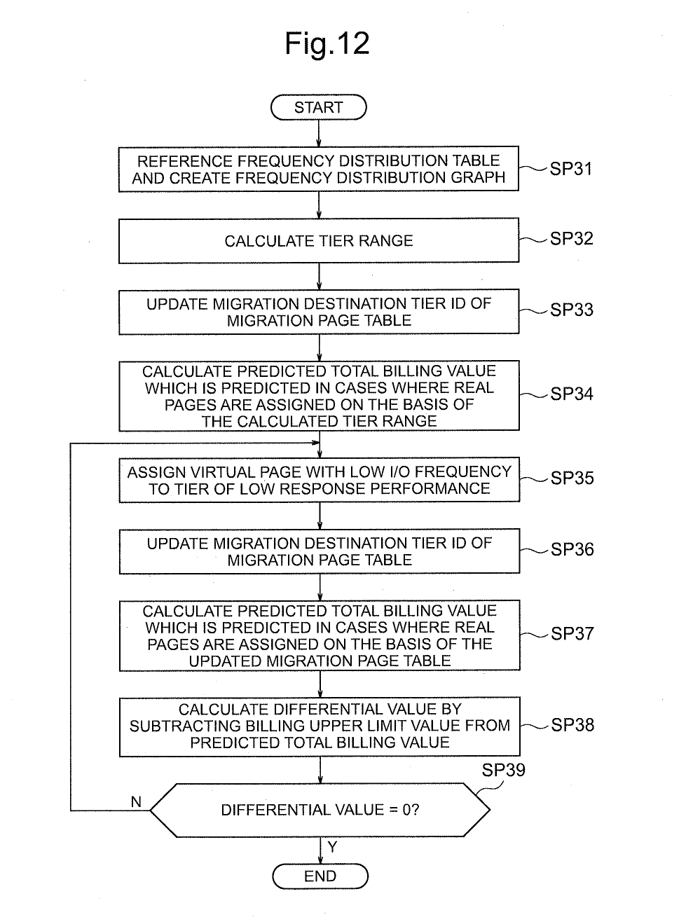

FIG. 12 shows a processing routine of tier range calculation processing in a case where the billing amount is reduced. This tier range calculation processing is executed, in response to the billing management processing (FIG. 10) moving to step SP16, on the basis of the frequency distribution calculation program 2137, the tier range calculation program 2138, the billing amount calculation program 2139, and the processor 212. For the sake of convenience in the description, the entity performing the processing will be described as the tier range calculation program 2138 or the billing amount calculation program 2139.

First, the frequency distribution calculation program 2137 references the frequency distribution table 2135 and creates the frequency distribution table 2135A (SP31). The tier range calculation program 2138 then calculates the tier range by assigning each tier to each virtual page in accordance with the I/O frequency (SP32).

For example, as is also illustrated in FIG. 9, the tier range calculation program 2138 configures an infinite I/O count as the upper limit value of the tier range TR1 of the highest response-performance tier #00. Meanwhile, for the lower limit value, the tier range calculation program 2138 assigns the real pages which belong to this tier #00 to the virtual pages, in order working through the real pages toward progressively smaller I/O frequencies from the upper limit value, and in a case where the sum total of the assigned real page counts reaches a point close to the upper limit value for the number of tier #00-assignable real pages, the tier range calculation program 2138 sets the I/O frequency at the time the upper limit value is reached as the lower limit value of the tier range TR1. The tier range calculation program 2138 also sets the upper limit value and the lower limit value in the same way for the tier ranges TR2 and TR3 of the tiers #01 and #02 which have a response performance inferior to that of the tier #00.

The tier range calculation program 2138 then assigns real pages of each tier to each virtual page in step SP32 and subsequently changes the migration destination tier ID field 21343 of the migration page table 2134 for the virtual pages with different assigned source tiers before and after assignment and updates the migration page table 2134 (SP33).

The billing amount calculation program 2139 then assumes that the write count in the next monitoring period is also the same as in the previous monitoring period and then references the write count management table 2131 and the write cost management table 2132 to calculate the total of the predicted billing amounts (predicted total billing value) in a case where real pages are assigned to virtual pages on the basis of the tier range calculated in step SP32 (SP34).

The tier range calculation program 2138 subsequently changes the assigned source tier such that the predicted total billing value calculated in step SP34 is reduced and such that, among the virtual pages contained in the tier range (tier range TR1, for example) of the high response performance tier (tier #00, for example), virtual pages with a low I/O frequency are put in a tier range (tier range TR2, for example) of a low response performance tier (tier #01, for example) (SP35).

For example, the tier range calculation program 2138 assigns among the virtual pages which belong to the high response performance tier #00, virtual pages with a low I/O frequency to tier #01, for example, which possesses a lower response performance than tier #00.

The tier range calculation program 2138 then changes the assigned source tier of the real page in step SP35 before then changing the migration destination tier ID field 21343 of the migration page table 2134 for the virtual pages with different assigned source tiers before and after the change and updates the migration page table 2134 (SP36).

The billing amount calculation program 2139 then assumes that the write count in the next monitoring period is also the same as in the previous monitoring period and then references the write count management table 2131 and the write cost management table 2132 to calculate the predicted total billing value that is predicted in a case where real pages are assigned on the basis of the migration page table 2134 updated in step SP36 (SP37).

The billing amount calculation program 2139 subsequently calculates a differential value by subtracting the predicted billing upper limit value from the predicted total billing value calculated in step SP37, and calculates the differential value (SP38).

In the case where the differential value is not 0, that is, where the predicted billing amount remains higher than the billing upper limit value, the tier range calculation program 2138 moves to step SP35 and repeats the processing described earlier. If, on the other hand, the differential value is 0, the predicted billing amount is the same as the billing upper limit value. Thus in this case the tier range calculation program 2138 ends the processing.

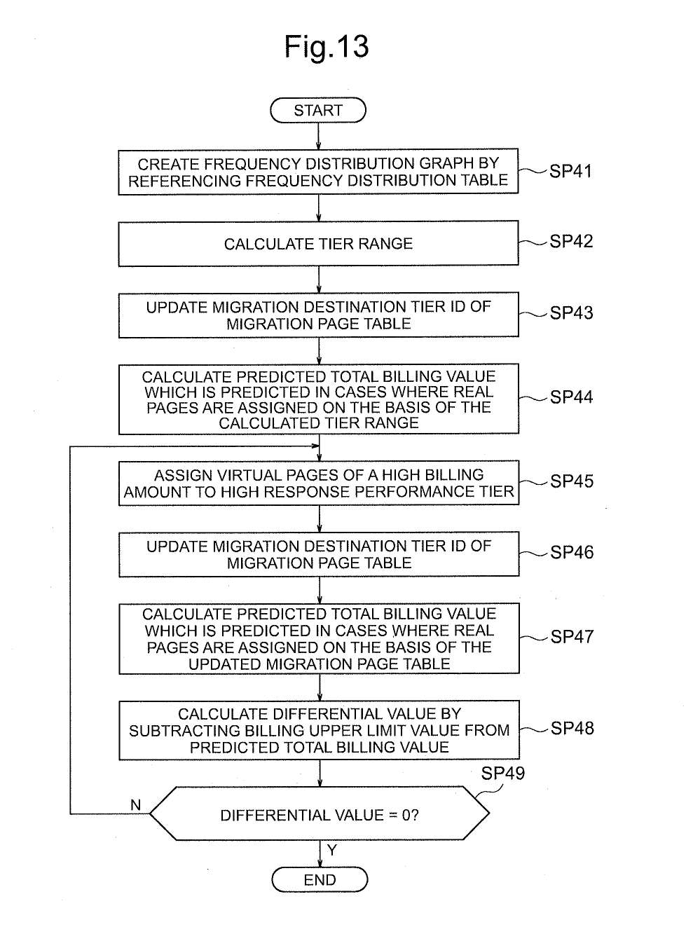

FIG. 13 shows a processing routine for tiering calculation processing in a case where the billing amount is increased. This tiering calculation processing is executed In response to the billing management processing (FIG. 10) moving to step SP17, on the basis of the tiering calculation program 2138, the billing amount calculation program 2139, and the processor 212. For the sake of convenience in the description, the entity performing the processing will be described as the tier range calculation program 2138 or the billing amount calculation program 2139.

The processing of steps SP41 to SP44 is the same as that of steps SP31 to SP34 in FIG. 12 and hence a description thereof will be omitted here.

The tier range calculation program 2138 assigns virtual pages with a high billing amount to the high response performance tier so as to increase the predicted total billing value calculated in step SP44 (SP45).

For example, among the virtual pages which belong to the low response performance tier #01, the tier range calculation program 2138 assigns virtual pages with a high billing amount in order to the high response performance tier #00.

The processing of steps SP46 to SP49 is the same as that of steps SP36 to SP39 of FIG. 12, and therefore a description will be omitted here. Note that, in step SP49, the tier range calculation program 2138 moves to step SP45 and repeats the processing described above in a case where the differential value is not 0, that is, in a case where the predicted billing amount remains lower than the billing upper limit value. If, on the other hand, the differential value is 0, the predicted billing amount is the same as the billing upper limit value. Accordingly, in this case, the tier range calculation program 2138 ends the processing.

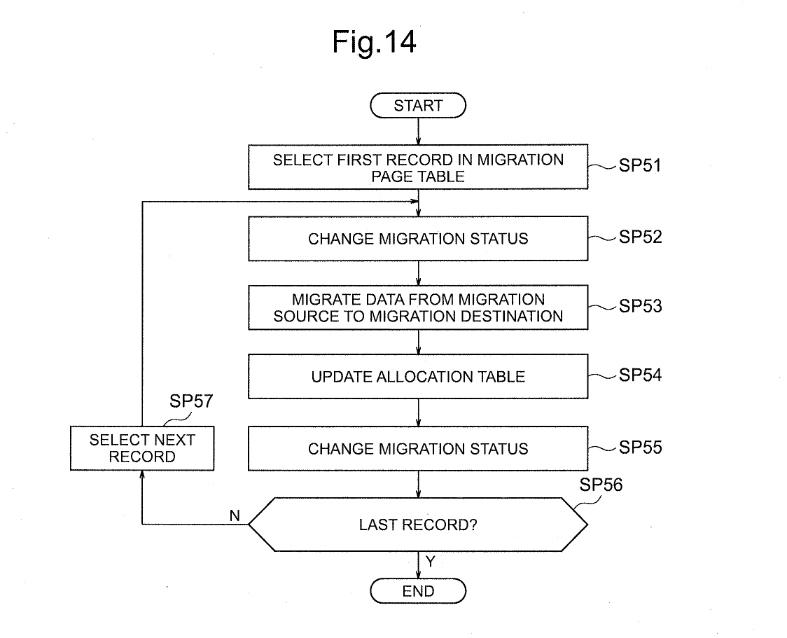

FIG. 14 shows a processing routine of migration processing by means of the storage tiering function. The migration processing is executed at regular intervals on the basis of the I/O control program 2136 and the processor 212. For the sake of convenience in the description, the entity performing the processing is described as the I/O control program 2136.

First, the I/O control program 2136 references the migration page table 2134 and selects the first record in the migration page table 2134 (SP51). The I/O control program 2136 subsequently updates the migration page table 2134 by changing the migration status of the selected record to “migration in progress” (SP52).

The I/O control program 2136 then references the migration page table 2134 and actually migrates the data of the real page assigned to the migration target virtual page from the migration source to the migration destination (SP53).

The I/O control program 2136 subsequently references the allocation table 2133, changes information on the migration destination which is associated with the migration target virtual page, and updates the allocation table 2133 (SP54).

The I/O control program 2136 then references the migration page table 2134, changes the migration status updated in step SP52 to “migrated”, and updates the migration page table 2134 (SP55).

The I/O control program 2136 subsequently determines whether or not the record selected in the migration page table 2134 is the last record (SP56). Upon obtaining a negative result in the determination of step SP56, the I/O control program 2136 selects the next record (SP57), moves to step SP52, and executes the foregoing processing. If, on the other hand, an affirmative result is obtained in the determination of step SP56, the I/O control program 2136 ends the processing.

(6) Advantageous Effect of this Embodiment

As described hereinabove, with the storage system according to this embodiment, because the billing amount is calculated in accordance with the write count, inequalities between users which arise in cases where billing is performed in accordance with the usage capacity can be resolved. According to this embodiment, because data is migrated in accordance with the billing amount such that the billing amount is close to the billing upper limit value, the billing amount can be easily predicted.

### REFERENCE SIGNS LIST

1 Storage system

10 Host

20 Storage apparatus

21 Controller

22 Physical storage device

221 SSD

222 SAS

223 SATA

1. A storage apparatus which calculates a billing amount in accordance with a data write count, comprising:
a physical storage device which provides logical volumes of different types; and
a controller which executes I/O control by classifying each of the logical volumes of different types into tiers of different response performances and associating each of the logical volumes which belong to any of the tiers with a virtual volume provided to a higher level device,
wherein, in a case where a write request is issued to any virtual page which configures the virtual volume, the controller assigns any real page which configures a logical volume to the virtual page, writes data to the real page, and performs a write count,
wherein the controller calculates a billing amount per fixed time interval on the basis of the performed write count,
wherein the controller calculates tier ranges of the tiers on the basis of an I/O frequency of the virtual page so that the billing amount per fixed time interval does not exceed the billing upper limit value, and
wherein the controller relocates the real page on the basis of the calculated tier range.

2. The storage apparatus according to claim 1,
wherein, if the billing amount per fixed time interval exceeds a preset billing upper limit value, the controller calculates the tier range so as to reduce the billing amount per fixed time interval.

3. The storage apparatus according to claim 1,
wherein the controller calculates the tier range so as to increase performance to an extent that the billing amount per fixed time interval does not exceed the billing upper limit value.

4. The storage apparatus according to claim 3,
wherein the controller calculates the tier range such that, if the billing amount per fixed time interval is lower than the billing upper limit value, the billing amount per fixed time interval increases.

5. The storage apparatus according to claim 3, further comprising:
a user interface for accepting operation by a user,
wherein, if the billing amount per fixed time interval is lower than the billing upper limit value, the controller determines whether or not to calculate the tier range so as to improve performance to an extent that the billing amount per fixed time interval does not exceed the billing upper limit value on the basis of an operation from the user interface.

6. A control method of a storage apparatus which calculates a billing amount in accordance with a data write count, comprising:
a first step in which a physical storage device provides logical volumes of different types; and
a second step in which a controller executes I/O control by classifying each of the logical volumes of different types into tiers of different response performances and associating each of the logical volumes which belong to any of the tiers with a virtual volume provided to a higher level device, and comprising, in the second step:
a third step in which, in a case where a write request is issued to any virtual page which configures the virtual volume, any real page which configures the logical volume is assigned to the virtual page, data is written to the real page, and a write count is performed;
a fourth step in which a billing amount per fixed time interval is calculated on the basis of the performed write count;
a fifth step in which tier ranges of the tiers are calculated on the basis of an I/O frequency so that the billing amount per fixed time interval does not exceed the billing upper limit value; and
a sixth step in which the real page is relocated on the basis of the calculated tier range.

7. The control method of a storage apparatus according to claim 6,
wherein, in the fifth step, if the billing amount per fixed time interval exceeds a preset billing upper limit value, the tier range is calculated so as to reduce the billing amount per fixed time interval.

8. The control method of a storage apparatus according to claim 6,
wherein, in the fifth step, the tier range is calculated so as to increase performance to an extent that the billing amount per fixed time interval does not exceed the billing upper limit value.

9. The control method of a storage apparatus according to claim 8,
wherein, in the fifth step, the tier range is calculated such that, if the billing amount per fixed time interval is lower than the billing upper limit value, the billing amount per fixed time interval increases.

10. The control method of a storage apparatus according to claim 8,
further comprising:
a seventh step in which the user interface receives operations from the user,
wherein, in the fifth step, if the billing amount per fixed time interval is lower than the billing upper limit value, it is determined whether or not to calculate the tier range so as to improve performance to an extent that the billing amount per fixed time interval does not exceed the billing upper limit value on the basis of an operation from the user interface received in the seventh step.
